(19) United States
(12) Patent Application Publication
(10) Pub. No.: US 2009/0154510 A1
(43) Pub. Date: Jun. 18, 2009

(54) Optoelectrical assembly with frequency-doubled solid state laser

(75) Inventors: Stefan Tiefenthaler, Meiningen (AU); Lieu-Kim Dang, Gams (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/317,007

(22) Filed: Dec. 17, 2008

(30) Foreign Application Priority Data
Dec. 18, 2007 (DE) 102007055848.3

(51) Int. Cl. H01S 3/10

(52) U.S. Cl. 372/22

(57) ABSTRACT

An optoelectrical assembly (1) has a modular frequency-doubled solid state laser (2), which is fixed so as to be aligned therein, with an optical resonator (3) which is connected in a thermally conducting manner to a heat source (5) which is controllable by controlling means (4). The operating temperature (T) of the solid state laser (2) is adjusted by the controlling means (4) to between 40° C. and 55° C.

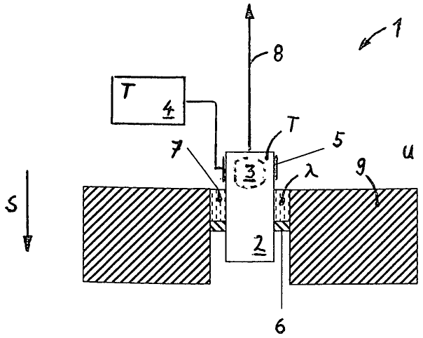

### BACKGROUND OF THE INVENTION

1. Field of the Invention

The invention is directed to an optoelectrical assembly with a frequency-doubled solid state laser, particularly a diode-pumped solid state laser (DPSS) with neodymium-doped yttrium orthovanadate (Nb:YVO4), whose IR laser beam of 1064 nm is frequency-doubled by an optically nonlinear crystal of potassium titanyl phosphate (KTP) inside the optical resonator in the green spectral region of 532 nm for use in optoelectrical marking systems such as construction lasers.

2. Description of the Prior Art

Optoelectrical marking systems are used in monomode operation (TEM00) in which the emitted frequency-doubled laser beam has only exactly one spatial energy maximum which accordingly results in exactly one round light spot when impinging on a reflecting target object. However, different operating modes can be excited in the optically nonlinear crystal depending on boundary conditions, particularly the ambient temperature. An operating temperature of 15° C. to 30° C. is usually specified for these frequency-doubled solid state lasers.

According to U.S. Pat. No. 5,495,489, the optical resonator in an optoelectrical assembly with a modular frequency-doubled solid state laser is combined with a coaxially circumferentially extending heat source and is regulated to an operating temperature of close to 30° C. by controlling means, i.e., is heated and cooled additionally by Peltier elements for different ambient temperatures depending on design, or is only cooled or only heated relative to the ambient temperature. The optical resonator is arranged coaxially inside the controllable heat source which is itself surrounded on the radial outer side by a coaxial heatsink with cooling ribs.

### SUMMARY OF THE INVENTION

It is an object of the invention to realize in a simple manner an optoelectrical assembly with a stable monomode frequency-doubled solid state laser for an ambient temperature range of from −20° C. to +45° C.

Another object of the invention is to ensure a to the suitable alignment of the optical axis of the frequency-doubled solid state laser inside the optoelectronic assembly.

These and other objects of the present invention which will become apparent hereinafter are achieved by providing an optoelectrical assembly having a modular frequency-doubled solid state laser which is fixed so as to be aligned therein and which has an optical resonator that is connected in a thermally conducting manner to a heat source controllable by controlling means, and wherein the operating temperature of the solid state laser is adjusted by the controlling means to between 40° C. and 55° C.

Because of the high operating temperature of the solid state laser which is unusual and uneconomical with respect to energy, active cooling can also be dispensed with in the ambient temperature range from −20° C. to +45° C. so that controllable heating means which are simpler and therefore less expensive (compared to a Peltier element) are sufficient as the controllable heat source. In case of a temperature-dependent resistance, the heat source can also be used as a temperature sensor at the same time.

The heating means is advantageously a (self-adhesive) heating foil which advantageously surrounds the optical resonator circumferentially so that it can be mounted in the area of the optical resonator of the modular frequency-doubled solid state laser in a simple manner.

The solid state laser is advantageously embedded in the optoelectrical assembly by means of a curable casting compound with a thermal conductivity in the range of 0.1 to 1.0 W/(Km) so that the casting compound provides for a defined flow of heat (for cooling by the ambient temperature, which is always lower) as well as for a simple radial and axial alignment of the solid state laser in the optoelectrical assembly.

The casting compound advantageously comprises gypsum or plaster which is advantageously provided with additives such as metal cuttings so that the thermal conductivity and curing time are adjustable in suitable ranges.

Sealing means for axial sealing is advantageously arranged between the modular solid state laser and the radially surrounding optoelectrical assembly so that this sealing means (arranged at the bottom during the optical alignment) prevents the still pasty casting compound from flowing off so that optical alignment is made easier.

The novel features of the present invention, which are considered as characteristic for the invention, are set forth in the appended claims. The invention itself, however, both as to its construction and its mode of operation, together with additional advantages and objects thereof, will be best understood from the following detailed description of a preferred embodiment, when read with reference to the accompanying drawings.

### BRIEF DESCRIPTION OF THE DRAWINGS

In the Drawings:

The single FIGURE shows a schematic diagram of the optoelectrical assembly according to the present invention.

### DETAILED DESCRIPTION OF THE PREFERRED EMBODIMENTS

As shown in the drawing, an optoelectrical assembly 1 has a modular frequency-doubled solid state laser 2 which is fixed so as to be aligned therein in the form of a diode-pumped solid state laser (DPSS) with neodymium-doped yttrium orthovanadate (Nb:YVO4), whose IR laser beam of 1064 nm is frequency doubled by an optically nonlinear crystal of potassium titanyl phosphate (KTP) inside an optical resonator 3 in the green spectral region of 532 nm and emits a focused green laser beam 8. The spatial area of the optical resonator 3 in the modular solid state laser 2 is connected in a thermally conducting manner to a heat source 5 in the form of a self-adhesive heating foil which is controllable by controlling means 4 in the form of a microcontroller. The temperature-dependent resistance of the heating foil, which surrounds the optical resonator 3 circumferentially, serves at the same time as a temperature sensor. Due to the fact that an operating temperature T of 50° C. is programmed as a reference value in the controlling means 4, the solid state laser 2 (after the initialization of the temperature control loop) is also operated at an operating temperature T of 50° C. Means 6 for axial sealing is are arranged between the modular solid state laser 2 and the radially surrounding it, optoelectrical assembly 1. During alignment, the sealing means 6 seals the occurring annular space for the radially surrounding optoelectrical assembly 1 in direction of the gravitational force G. This annular space is filled with a curable casting compound 7 of plaster with metal cuttings and with a thermal conductivity λ of 0.1 to 1.0 W/(Km) (the thermal conductivity λ of the metal cuttings is between approximately 10 to 100 W/(Km)). After this casting compound 7 hardens, the solid state laser 2 is embedded in the radially surrounding optoelectrical assembly 1 so as to be aligned axially and radially. By means of the thermal conductivity λ of 0.1 to 1.0 W/(Km) of the casting compound 7, which thermal conductivity λ is adjusted in a defined manner by metal cuttings, most of the heat from the heat source 5 and the solid state laser 2 flows to the metal holder 9 of the optoelectrical assembly 1 which is passively cooled by the surrounding temperature U of 45°.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. Optoelectrical assembly comprising a modular frequency-doubled solid state laser (2) adjustably securable therein and including an optical resonator (3); a heat source (5) for heating the solid state laser (2), the optical resonator (3) being connected with the heat source (5) in a thermally conductive manner; and means (4) for controlling the heat source (5) so that an operating temperature (T) of the solid state laser (2) is adjusted in a range from 40° C. and 55° C.

2. An optoelectrical assembly according to claim 1, wherein the heat source (5) is a heating foil.

3. An optoelectrical assembly according to claim 1, wherein the solid state laser (2) is embedded by means of a curable casting compound (7) with a thermal conductivity (λ) in the range of 0.1 to 1.0 W/(Km).

4. An optoelectrical assembly according to claim 3, wherein the casting compound (7) comprises plaster.

5. An optoelectrical assembly according to claim 1, further comprising means (6) for axially sealing the modular solid state laser (2).
